(19) United States
(12) Patent Application Publication
(10) Pub. No.: US 2008/0113644 A1
(43) Pub. Date: May 15, 2008

(54) Low Noise Mixer

(76) Inventors: Saverio Trotta, Munchen (DE); Bernhard Dehlink, Unterhaching (DE)

Correspondence Address: ESCHWEILER & ASSOCIATES LLC, 629 EUCLID AVENUE, SUITE 1000, NATIONAL CITY BUILDING, CLEVELAND, OH, 44114, US

(21) Appl. No.: 11/559,705

(22) Filed: Nov. 14, 2006

(51) Int. Cl. H04B 1/40

(52) U.S. Cl. 455/333

(57) ABSTRACT

A mixer apparatus has a double-balanced or Gilbert-cell based mixer core and respective transmission lines, inductors in particular, between the local oscillating (LO) differential pair of transistors and the radio frequency (RF) transistors, wherein the transmission lines are so formed as to minimize the noise, improve common-mode stability of said local oscillating input port and linearity of the mixer apparatus.

### TECHNICAL FIELD

The present invention relates to mixers and, more particularly, to a double-balanced Gilbert-cell based mixer with low-noise performance and improved common-mode stability and linearity.

### BACKGROUND

Radio receivers typically receive a radio frequency (RF) signal and down-convert it to a signal having a lower frequency, which is easier to amplify, filter and process. This is usually accomplished in a mixer that mixes the RF signal with a local oscillating (LO) signal having a different frequency. The mixer then outputs an intermediate frequency (IF) signal that is further processed by the receiver.

Similarly, a radio transmitter typically receives an IF signal and up-converts it to a signal having higher, radio frequency for transmission. This is usually accomplished in a mixer that mixes the IF signal with a LO signal having a different frequency. The mixer then outputs a RF signal.

Also, mixing is commonly used in communication systems, such as in cellular communications and cordless telephony or television. For example, a handset receives a RF signal and down-converts the signal via a mixer to an IF signal. It is important that the mixer is low noise so that it does not significantly degrade or mask the information contained in the original RF signal.

For example, a traditional Gilbert cell, as illustrated in FIG. 1, provides an output IF that has components at frequencies equal to both the sum of and the difference between the input signal frequencies at the inputs LO and RF. As the number of mixers based on, for example, traditional Gilbert cells increases, so will the demand for mixers with simultaneously reduced noise, improved common-mode stability at the LO port and linearity.

Typically, in order to improve the linearity of conventional mixers, a combination of very large transistors and resistive or inductive degeneration is used. Moreover, the values of the load resistors R_{L} illustrated in FIG. 1 are decreased in order to reduce the gain and thereby improve the linearity of the mixer. Although, inductive or resistive degeneration has no influence on the behaviour of the LO port regarding switching speed and stability.

### BRIEF DESCRIPTION OF THE DRAWINGS

Characteristics and advantages thereof will be evident from the following detailed description of the embodiments of the invention and the accompanying FIG. 1 to 6, which are given by way of illustration only, and thus are not limited to the present embodiments of the invention.

FIG. 1 illustrates a double-balanced mixer, also known as Gilbert cell;

FIG. 2 illustrates a first embodiment;

FIGS. 3 and 4 serve for explaining background aspects;

FIG. 5 illustrates part of an embodiment including representative (parasitic) capacitance;

FIG. 6 illustrates another embodiment;

FIG. 7 illustrates the noise figure (m12-m3) and conversion gain (m11-m2) performances at different temperatures of a mixer without inductors;

FIG. 8 illustrates the noise figure (m12-m3) and conversion gain (m11-m2) performances at different temperatures of a mixer with inductors;

FIG. 9 illustrates common-mode stability at the LO port of a mixer without inductors;

FIG. 10 illustrates common-mode stability at the LO port of a mixer with inductors;

FIG. 11 illustrates linearity (compression point) of a mixer without inductors; and

FIG. 12 illustrates linearity (compression point) of a mixer with inductors.

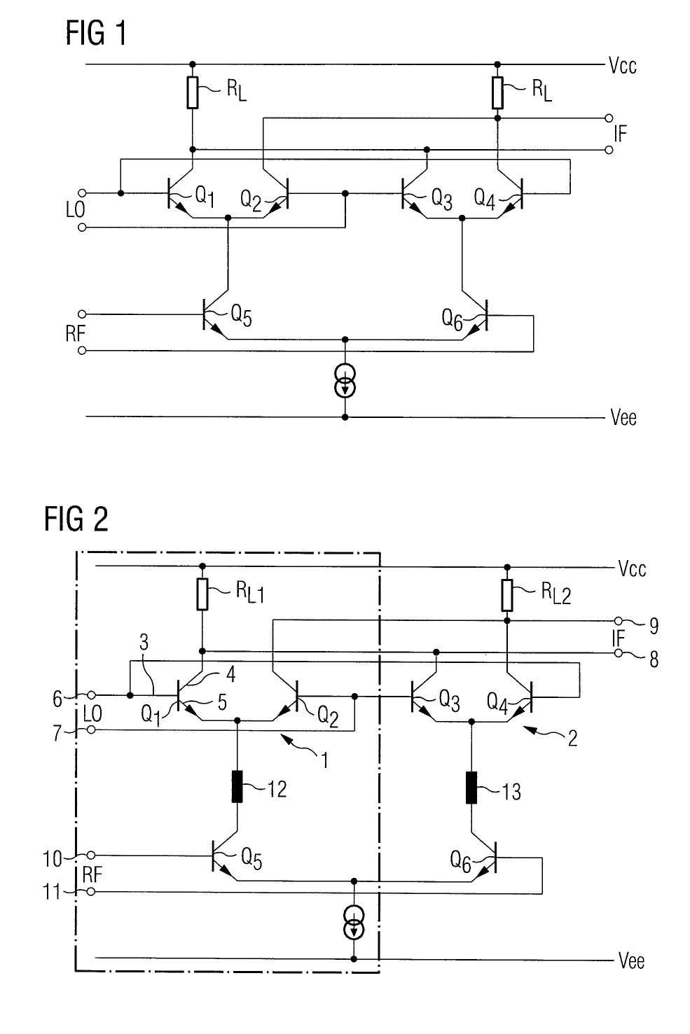

### DETAILED DESCRIPTION

FIG. 2 shows a mixer apparatus according to an embodiment, wherein the mixer apparatus, a modified double-balanced mixer, comprises a first differential transistor pair 1, comprising a first Q1 and a second transistor Q2, a second differential transistor pair 2, comprising a third Q3 and a fourth transistor Q4, and further comprising a fifth transistor Q5 and a sixth transistor Q6, each transistor comprising a base 3, a collector 4 and an emitter 5.

The mixer apparatus further comprises a local oscillating input port 6 coupled to the base 3 of the first Q1 and fourth transistor Q4 and a reversed local oscillating input port 7 coupled to the base 3 of the second Q2 and third transistor Q3.

The emitters 5 of the first Q1 and second transistor Q2 are coupled together and connected to the collector 4 of the fifth transistor Q5 and the emitters 5 of the third Q3 and fourth transistor Q4 are coupled together and connected to the collector 4 of the sixth transistor Q6. The collectors 4 of the first Q1 and third transistor Q3 are coupled together and connected to an intermediate frequency output port 8 and the collectors 4 of the second Q2 and fourth transistor Q4 are coupled together and connected to a reversed intermediate frequency output port 9, wherein the collector 4 of the first Q1 and fourth transistor Q4 is coupled to a positive supply voltage Vcc via a first R_{L1} and second resistor R_{L2}, respectively.

The mixer apparatus further comprises a radio frequency input port 10 that is coupled to the base 3 of the fifth transistor Q5 and a reversed radio frequency input port 11 that is coupled to the base 3 of the sixth transistor Q6, wherein the emitters 5 of the fifth Q5 and sixth transistor Q6 are coupled together and connected to a negative supply voltage Vee.

According to an embodiment, a first transmission line or inductor 12, acting as a first filter, is coupled between the emitters 5 of the first Q1 and second transistor Q2 and the collector 4 of the fifth transistor Q5, and a second transmission line or inductor 13, acting as a second filter, is coupled between the emitters 5 of the third Q3 and fourth transistor Q4 and the collector 4 of the sixth transistor Q6. Preferably the first and second transmission lines 12 and 13 are so formed as to minimize the noise, improve common-mode stability of the local oscillating input port and linearity of the mixer apparatus of the embodiment. Furthermore, in an embodiment, the fifth transistor Q5 and sixth transistor Q6 are larger than any of the transistors Q1 to Q4.

Preferably, the transistors Q1 to Q6 are of the npn-type but may, in principle, be replaced with nMOS transistors, in particular for high-frequency applications. As far as basic ideas of the invention may be transformed into a circuit structure formed with transistors of the pnp-type, in principle, a replacement of the latter by pMOS transistors is possible. As a matter of fact, in such case the circuit topology has to be adapted to the specific requirements of unipolar transistors.

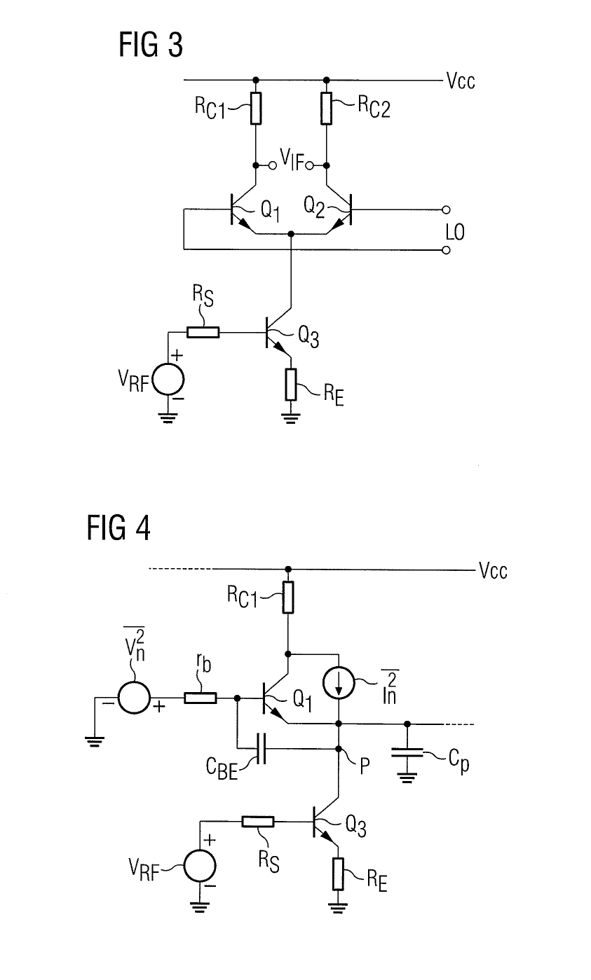

Essential features of the embodiment described above are best understood using an ideal switch circuit of a single-balance mixer as illustrated in FIG. 3 and FIG. 4. FIG. 4 shows part of the single-balanced mixer illustrated in FIG. 3 in more detail including representative capacitance C_{P} and resistance r_{b}, R_{S} and R_{E}.

Here, each of the transistors Q1 and Q2 is “on” for approximately half of the LO period. Injecting noise, due to the parasitic capacitance C_{P} at the node P, provides a finite impedance to ground. Hence, the thermal base noise and the collector current noise, also known as shot noise, are transferred to the intermediate frequency by the switching action of the transistors Q1 and Q2.

For non-ideal switching Q1 and Q2 are both “on” for a small period of time. During this time, transistors Q1 and Q2 amplify the thermal noise of their base resistance r_{b} and inject their collector shot noise to the IF output ports 8 and 9. Therefore, the noise contribution from transistors Q1 and Q2 can be minimized using a large local oscillating swing.

However, the capacitance C_{P} can not easily be reduced, because the transistors Q1 and Q2 are working with their best current density, thus, their size is fixed. This means, that the base to emitter capacitance C_{BE} is fixed too. Furthermore, the transistors Q5 and Q6, illustrated in FIG. 2, have to be larger than any of the transistors Q1 to Q4 in order to improve the linearity of the mixer and to reduce the thermal noise from their bases 3.

Therefore, in order to reduce the value of the collector to base capacitance C_{CB} and the value of the collector to substrate capacitance C_{CS}, an inductor 12 is coupled between the LO differential pair Q1 and Q2 and the RF transistor Q5 as illustrated in FIG. 5.

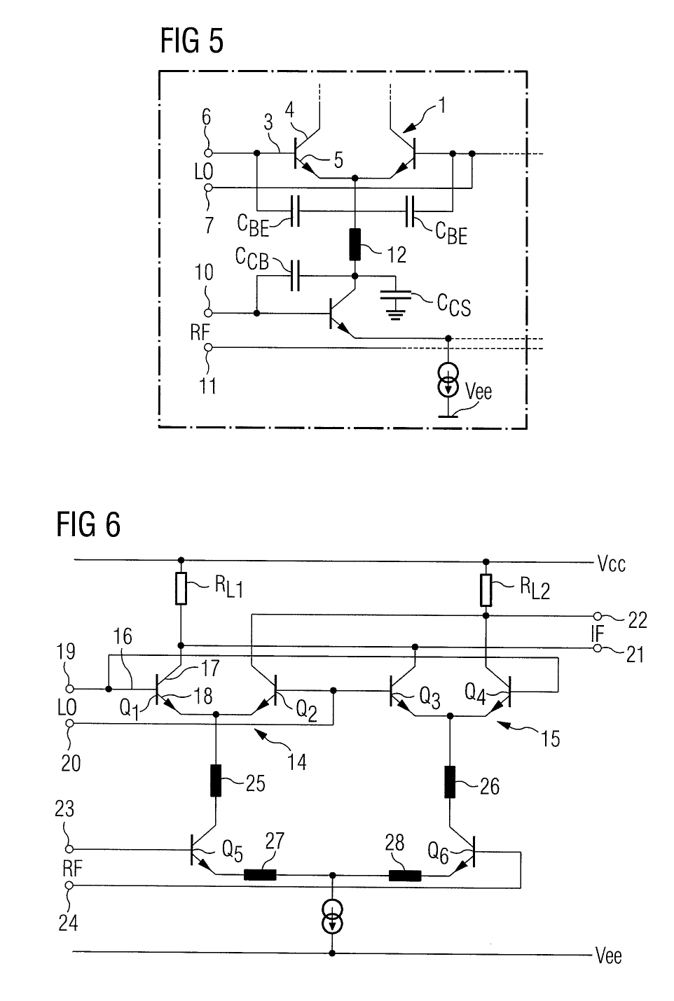

FIG. 6 shows a mixer apparatus according to another embodiment, wherein the mixer apparatus comprises a first differential transistor pair 14, comprising a first Q1 and a second transistor Q2, a second differential transistor pair 15, comprising a third Q3 and a fourth transistor Q4, and further comprising a fifth transistor Q5 and a sixth transistor Q6, each transistor comprising a base 16, a collector 17 and an emitter 18. The mixer apparatus further comprises a local oscillating input port 19 coupled to the base 16 of the first Q1 and fourth transistor Q4 and a reversed local oscillating input port 20 coupled to the base 16 of the second Q2 and third transistor Q3.

The emitters 18 of the first Q1 and second transistor Q2 are coupled together and connected to the collector 17 of the fifth transistor Q5 and the emitters 18 of the third Q3 and fourth transistor Q4 are coupled together and connected to the collector 17 of the sixth transistor Q6. The collectors 17 of the first Q1 and third transistor Q3 are coupled together and connected to an intermediate frequency output port 21 and the collectors 17 of the second Q2 and fourth transistor Q4 are coupled together and connected to a reversed intermediate frequency output port 22, wherein the collector 17 of the first Q1 and fourth transistor Q4 is coupled to a positive supply voltage Vcc via a first R_{L1} and second resistor R_{L2}, respectively.

The mixer apparatus further comprises a radio frequency input port 23 that is coupled to the base 16 of the fifth transistor Q5 and a reversed radio frequency input port 24 that is coupled to the base 16 of the sixth transistor Q6, wherein the emitters 18 of the fifth Q5 and sixth transistor Q6 are coupled together and connected to a negative supply voltage Vee.

According to an embodiment, a first transmission line 25 is coupled between the emitters 18 of the first Q1 and second transistor Q2 and the collector 17 of the fifth transistor Q5, and a second transmission line 26 is coupled between the emitters 18 of the third Q3 and fourth transistor Q4 and the collector 17 of the sixth transistor Q6, wherein the first and second transmission line 25 and 26 are so formed as to minimize the noise, improve common-mode stability of the local oscillating input port 19, 20 and linearity of the mixer apparatus. Furthermore, the emitters 18 of the fifth Q5 and sixth transistor Q6 are respectively coupled to emitter degeneration means 27, 28 and connected to a current source which is connected to the negative voltage supply Vee.

Preferably, the first transmission line 25, the second transmission line 26 and the emitter degeneration means 27 and 28 are inductors, respectively. In addition, the fifth Q5 and sixth transistor Q6 are larger than any of the transistors Q1 to Q4.

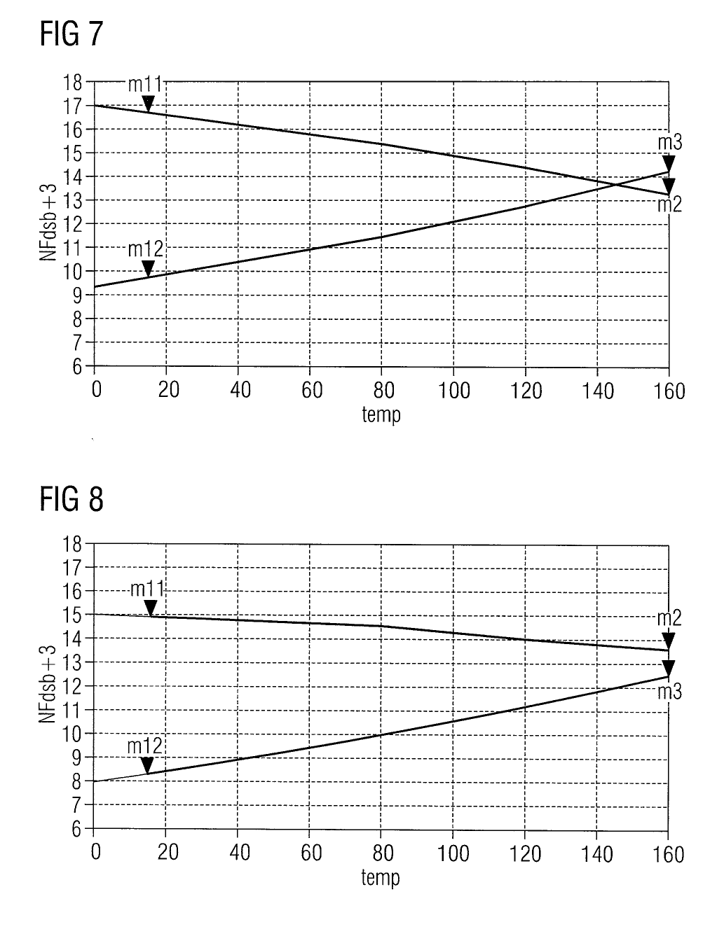

FIG. 7 and FIG. 8 show example diagrams illustrating the effect of the inductors 12, 13 of an embodiment on the capacitance C_{P} as illustrated in FIG. 4. Here, FIG. 7 illustrates the noise figure m12-m3 and the conversion gain m11-m2 performances at different temperatures of a mixer without inductors, and FIG. 8 illustrates the noise figure m12-m3 and conversion gain m11-m2 performances at different temperatures of an embodiment as described above.

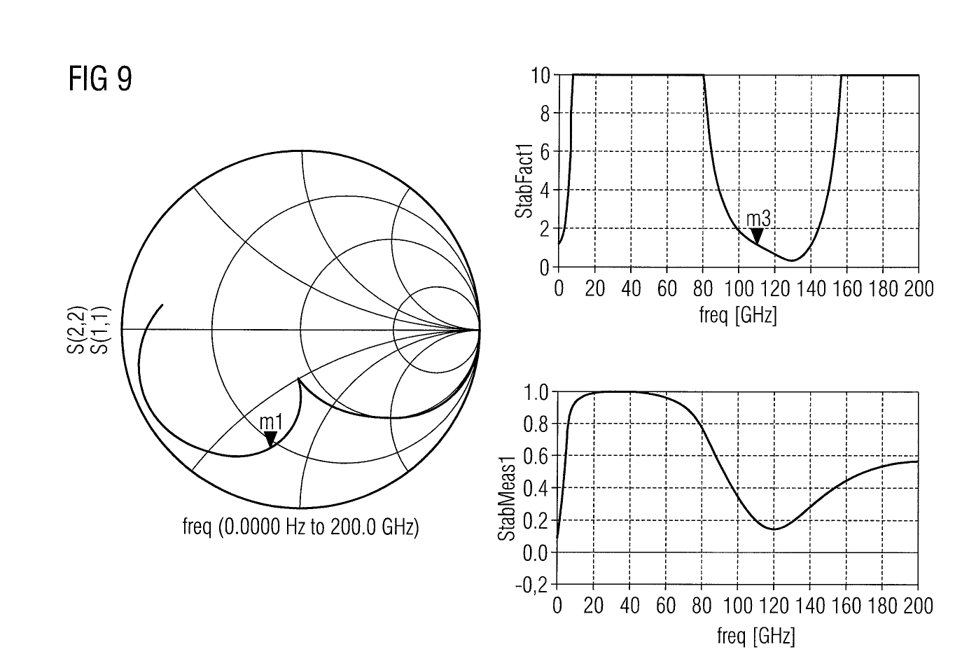

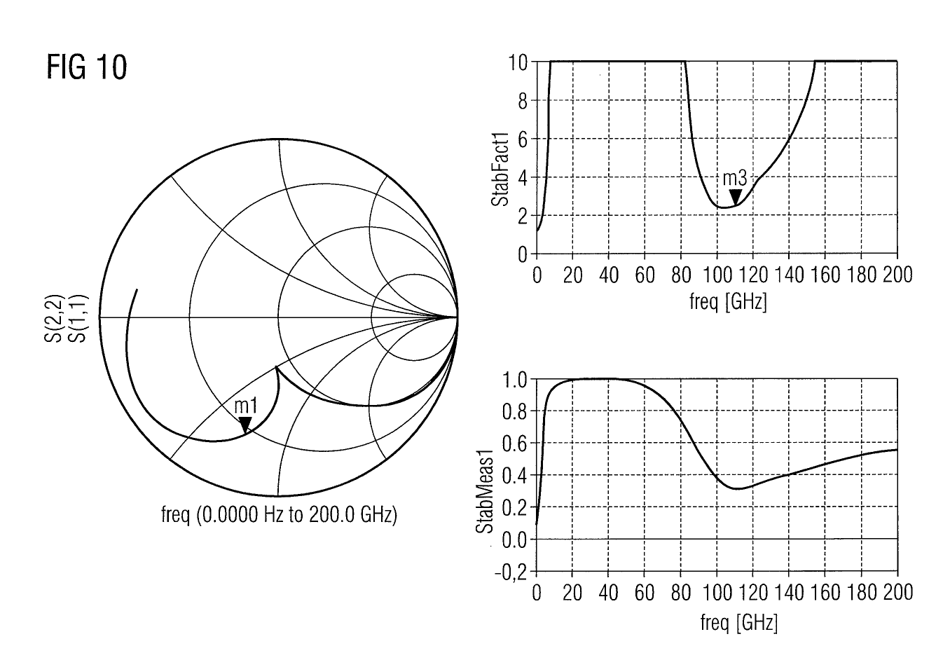

Furthermore, the inductors 12, 13 or 25, 26 of the different embodiments improve the common-mode stability of the local oscillating port 6, 7 or 19, 20, because the inductors 12, 13 or 25, 26 transform the input impedance of the transistors Q1 to Q4 and improve the common mode rejection ratio of the LO differential pairs Q1-Q2 Q3-Q4. FIG. 9 illustrates diagrams showing the common-mode stability at the local oscillating port 6, 7 without the inductors 12, 13. FIG. 10 illustrates diagrams showing the common-mode stability at the local oscillating port 6, 7 with the inductors 12, 13 of an embodiment.

In addition, the inductors 12, 13 or 25, 26 used in embodiments, improve the linearity of the mixer illustrated in FIG. 2 and FIG. 6. The reason for the improvement is the decoupling of the RF and the LO stages provided by the inductors 12, 13 or 25, 26. The two base to emitter capacitances C_{BE} of the LO differential pair Q1 and Q2, as shown in FIG. 5, have an influence on the currents in the path between the LO differential pairs Q1, Q2 and Q3, Q4 and RF differential pairs Q5, Q6. The current in that path is not constant, thus, showing some peaks that depend on the load capacitance, the voltage swing and the rise and fall time of the signal.

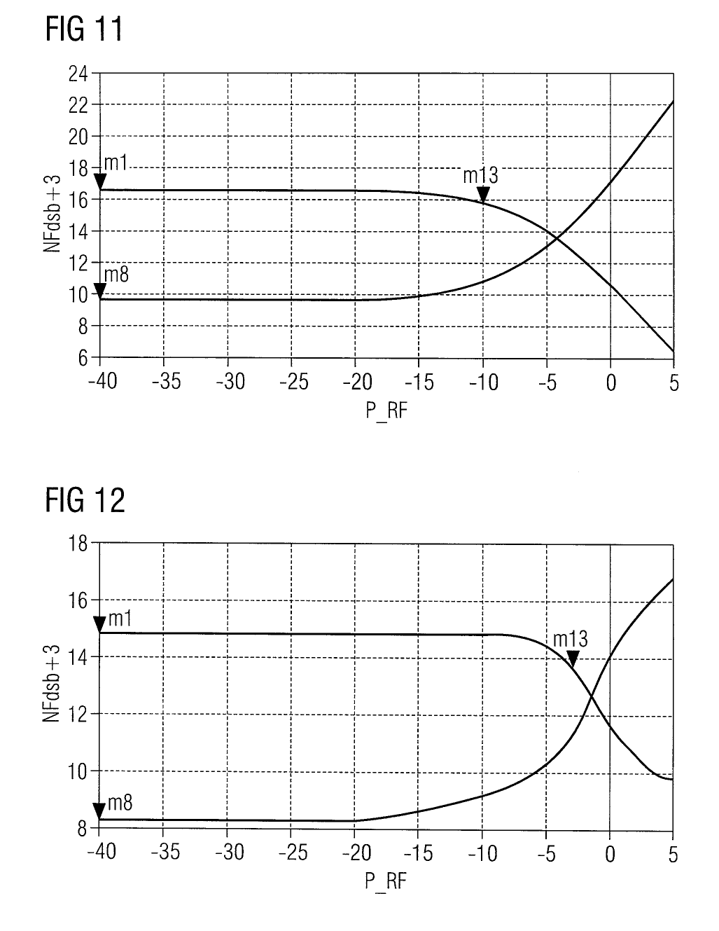

Also, the inductors 12, 13 reduce the effect of the two base to emitter capacitances C_{BE} on the current. Thus, the current peaks will be lower and therefore the gain will be reduced, improving the linearity of the mixer of an embodiment. FIG. 11 illustrates a diagram showing an example for the linearity, also known as compression point, without inductors. FIG. 12 illustrates a diagram showing an example for the linearity, also known as compression point, with inductors 12, 13 of an embodiment.

The inductors (or transmission lines) 27 and 28 improve the common mode stability at the RF port which is reduced by introduction of the inductors 25 and 26 (or 12 and 13).

What is claimed is:

1. A mixer apparatus comprising a first differential transistor pair, comprising a first and a second transistor, and a second differential transistor pair, comprising a third and a fourth transistor, and further comprising a fifth transistor and a sixth transistor, each transistor comprising a base, a collector and an emitter;
said mixer apparatus further comprising a local oscillating input port coupled to the base of said first and fourth transistor and a reversed local oscillating input port coupled to the base of said second and third transistor;
wherein the emitters of said first and second transistor are coupled together and connected to the collector of said fifth transistor via a first filter, and the emitters of said third and fourth transistor are coupled together and connected to the collector of said sixth transistor via a second filter; and
wherein the collectors of said first and third transistor are coupled together and connected to an intermediate frequency output port, and the collectors of said second and fourth transistor are coupled together and connected to a reversed intermediate frequency output port;
said mixer apparatus further comprising a radio frequency input port that is coupled to the base of said fifth transistor and a reversed radio frequency input port that is coupled to the base of said sixth transistor.

2. The mixer apparatus of claim 1, wherein said first filter comprises a first inductor and said second filter comprises a second inductor.

3. The mixer apparatus of claim 1, wherein said first filter comprises a first transmission line and said second filter comprises a second transmission line.

4. The mixer apparatus of claim 2, wherein said first filter comprises a first transmission line and said second filter comprises a second transmission line.

5. The mixer apparatus of claim 1, wherein the first and second filter are adapted to minimize the noise and to improve common-mode stability of said local oscillating input port and linearity of the mixer apparatus.

6. The mixer apparatus of claim 1, wherein the collector of said first and fourth transistor is coupled to a positive supply voltage via a first and second resistor, respectively.

7. The mixer apparatus of claim 1, wherein the emitters of said fifth and sixth transistor are coupled together and connected to a current source which is connected to a negative supply voltage.

8. The mixer apparatus of claim 1, wherein said fifth and sixth transistor are larger than any of said first to fourth transistor.

9. A mixer apparatus comprising a first differential transistor pair, comprising a first and a second transistor, and a second differential transistor pair, comprising a third and a fourth transistor, and further comprising a fifth transistor and a sixth transistor, each transistor comprising a base, a collector and an emitter;
said mixer apparatus further comprising a local oscillating input port coupled to the base of said first and fourth transistor and a reversed local oscillating input port coupled to the base of said second and third transistor;
wherein the emitters of said first and second transistor are coupled together and connected to the collector of said fifth transistor via a first filter and the emitters of said third and fourth transistor are coupled together and connected to the collector of said sixth transistor via a second transmission line, wherein the collectors of said first and third transistor are coupled together and connected to an intermediate frequency output port, and the collectors of said second and fourth transistor are coupled together and connected to a reversed intermediate frequency output port;
said mixer apparatus further comprising a radio frequency input port that is coupled to the base of said fifth transistor and a reversed radio frequency input port that is coupled to the base of said sixth transistor, wherein the emitters of said fifth and sixth transistor are respectively coupled to emitter degeneration means.

10. The mixer apparatus of claim 9, wherein said first and second filters comprise a first and second inductor, respectively.

11. The mixer apparatus of claim 9, wherein said first and second filters comprise a first and second transmission line, respectively.

12. The mixer apparatus of claim 10, wherein said first and second filters comprise a first and second transmission line, respectively.

13. The mixer apparatus of claim 9, wherein said first and second filter are adapted to minimize the noise and to improve common-mode stability of said local oscillating input port and linearity of the mixer apparatus.

14. The mixer apparatus of claim 9, wherein the collectors of said first and fourth transistor are coupled to a positive supply voltage via a first and second resister, respectively.

15. The mixer apparatus of claim 9, wherein the emitters of said fifth and sixth transistor are connected to a current source which is connected to a negative supply voltage.

16. The mixer apparatus of claim 9, wherein said emitter degeneration means comprise a third and a fourth inductor.

17. The mixer apparatus of claim 9, wherein an inductance of said third and fourth inductor is very small compared with said first and second inductor.

18. The mixer apparatus of claim 9, wherein said mixer apparatus comprises a Gilbert cell.

19. The mixer apparatus of claim 9, wherein said fifth and sixth transistor are larger than any of said first to fourth transistor.

20. A method of mixing an input signal with a radio frequency signal using a mixer apparatus comprising a first differential transistor pair, comprising a first and a second transistor, and a second differential transistor pair, comprising a third and a fourth transistor, and further comprising a fifth transistor and a sixth transistor, each transistor comprising a base, a collector and an emitter; the method comprising the steps of:
feeding said input signal to the bases of said first and fourth transistor and a reversed input signal to the bases of said second and third transistor;
feeding a first intermediate output signal from coupled emitters of said first and second transistor to the collector of said fifth transistor via a first filter, and a second intermediate output signal from coupled emitters of said third and fourth transistor to the collector of said sixth transistor via a second filter;
feeding the radio frequency input signal to the base of said fifth transistor and a reversed radio frequency signal to the base of said sixth transistor; and
outputting an output signal from coupled collectors of said first and third transistor, and from coupled collectors of said second and fourth transistor.
